(19) United States
(12) Patent Application Publication
(10) Pub. No.: US 2019/0270552 A1
(43) Pub. Date: Sep. 5, 2019

(54) QUICK CONNECT MOUTHPIECE FOR LIQUID CONTAINER

(71) Applicant: SAGAN LIFE LLC, Cedar City, UT (US)

(72) Inventors: Dennis M. Clements, Cedar CIty, UT (US); Richard B. Muit, San Diego, CA (US)

(21) Appl. No.: 16/418,545

(22) Filed: May 21, 2019

Related U.S. Application Data
(62) Division of application No. 15/298,080, filed on Oct. 19, 2016.
(60) Provisional application No. 62/243,855, filed on Oct. 20, 2015.
(60) Provisional application No. 62/295,978, filed on Feb. 16, 2016.

(51) Int. Cl. B65D 47/06; B65D 41/04; B65D 47/20; C02F 1/00; B65D 23/10; B65D 1/02; A45F 3/16; B65D 47/08; B65D 51/16

(52) U.S. Cl. CPC B65D 47/065; B65D 41/04; B65D 47/2025; C02F 1/003; B05B 11/3032; B65D 1/0246; A45F 3/16; B65D 47/0857; B65D 51/1616; B65D 23/10

(57) ABSTRACT

A fluid filtration system for use in a lid of a fluid container, such as a water bottle or water jug, that is adapted to receive a quick disconnect fitting and a pressurization source. The quick disconnect fitting is connected to flexible tubing which can be used to withdraw fluid from the water bottle by using pressure as a motive force. A fluid filtration system for use in a lid of a fluid container, such as a water bottle, water jug, or barrel that comprises a lid configured to attach to a container. The filter is in fluid communication with the lid through an outlet port. An external pressure source pumps the fluid through the filter through an outlet valve on the outlet port of the lid.

### BACKGROUND

### Field

The present application relates to a lid or mouthpiece for use with a liquid container and a pressurization and filtration system.

### BRIEF DESCRIPTION OF THE DRAWINGS

FIG. 1 is a perspective view of a mouthpiece for a liquid container having a quick connect fitting.

FIG. 2A is a depiction of the mouthpiece of FIG. 1 installed in the lid of a water bottle with the mouthpiece extended.

FIG. 2B is a depiction of the mouthpiece of FIG. 1 installed in the lid of a water bottle with the mouthpiece retracted.

FIG. 3 is a depiction of the mouthpiece of FIG. 1 with quick disconnect fitting and tubing attached thereto.

FIG. 4 depicts an embodiment of a water filtration system for use with a fluid container.

FIG. 5A is a top perspective view of an embodiment of a lid for use in a water filtration system.

FIG. 5B is a bottom perspective view of an embodiment of a lid for use in a water filtration system.

FIG. 5C depicts an embodiment of a filter system for use in a water filtration system.

FIG. 6 depicts an embodiment of a hand-tightenable lid having a male thread having a pressurization port.

FIG. 7 depicts an embodiment of a hand-tightenable lid having a male thread without a pressurization port.

### SUMMARY

Some embodiments described herein include a fluid delivery apparatus comprising: a lid configured to connect to a fluid reservoir; a mouthpiece having a proximal and distal end, the proximal end being configured to receive a fitting and the distal end connected to the lid such that a fluid channel is formed through the lid and the mouthpiece, wherein the fitting is configured to removably attach to the proximal end of the mouthpiece; tubing having a first end and a second end, the first end connected to the fitting to form a fluid channel; and a valve connected to second end of the tubing, wherein the valve is adapted to transmit a motive force to withdraw a fluid from the fluid reservoir, through the lid and the mouthpiece, and into the tubing.

In some embodiments, the fitting is a quick disconnect-type fitting.

In some embodiments, the lid comprises a plurality outlets, wherein each of the plurality of outlets has a fitting attached thereto.

In some embodiments, the valve is a bite valve.

In another aspect described herein, the fluid filtration system comprises a lid configured to attach to a container, the lid comprising an outlet port and a pressurization port; a filter in fluid communication with the outlet port; a pressure source in fluid communication with the pressurization port; an outlet valve in fluid communication with the outlet port; and wherein the pressure source is configured to apply a pressure to the container to which the lid is attached sufficient to force a fluid in the container through the filter and out the outlet valve.

In some embodiments, the outlet port comprises an internal portion and an external portion, and wherein an outlet channel formed between the internal and external portions of the outlet port.

In some embodiments, the filter is directly connected to the outlet port.

In some embodiments, the filter system comprises a plurality of filters in fluid communication with the outlet port.

In some embodiments, the lid further comprises a plurality of outlet ports and a plurality of outlet valves in fluid communication with the plurality outlet ports.

In some embodiments, the pressurization port is formed having a pressurization channel formed therein, wherein the pressurization channel extends through the lid and provides a fluid communication path between an environment external to the fluid container on which the lid is located and the internal volume of the container on which the lid is located.

In some embodiments, the pressure source is a hand pump.

In some embodiments, the container comprises a bung orifice.

In another aspect described herein, a method for fluid filtration from a container, comprises inserting a filter into a container holding a fluid; attaching a lid to said container, the lid comprising an outlet port having an internal portion and an external portion, and a pressurization port, attaching the filter to the internal portion of the outlet port on the lid; attaching a pressure source to the pressurization port, applying a pressure to the container from the pressure source sufficient to force a fluid in the container through the filter; and attaching a discharge valve to the external portion of the outlet port; and dispensing said fluid through the outlet port.

In some embodiments, the pressure source is a hand pump, and applying the pressure to the container comprises pumping the hand pump.

In some embodiments, the filter is attached to a first conduit, and wherein attaching the filter to the internal portion of the outlet port comprises attaching an end of the first conduit to the internal portion of the outlet port.

In some embodiments, attaching a discharge valve to the external portion of the outlet port comprises attaching a first end of a second conduit to the external portion of the outlet port and a second end of the second conduit to the discharge valve.

In some embodiments, the lid comprises a plurality of outlet ports, and wherein inserting the filter into the container comprises inserting a plurality of filters into the container, and attaching a plurality of first conduits to a plurality of internal portions of the plurality of outlet ports.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein and as illustrated in the figures, can be arranged, substituted, combined and designed in a wide variety of configurations, all of which are explicitly contemplated and made part of this disclosure.

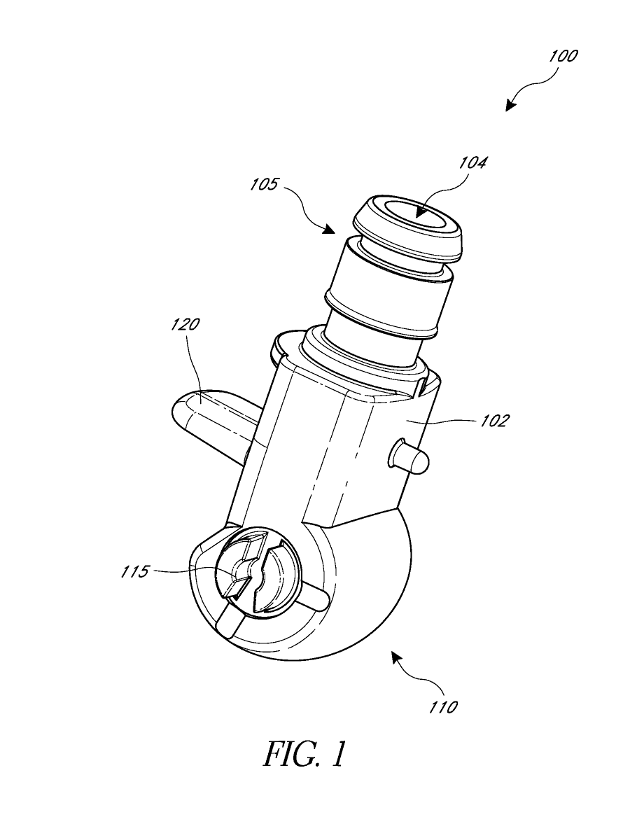

FIG. 1 depicts a perspective view of an exemplary mouthpiece for a liquid container having a quick connect fitting. The mouthpiece 100 includes a body 102. The body 102 can be formed of a rigid or semi rigid material. In some embodiments, the body 102 is formed of plastic, aluminum, resin, polycarbonate, or any other desired material. The body 102 having a proximal end 105 and a distal end 110, and a channel 104 running therethrough. The body 102 also includes an attachment feature 115. The attachment feature 115 connects the mouthpiece 100 to a lid (not shown). In some embodiments, the attachment feature 115 fits into a corresponding feature (not shown) on a which allows the mouthpiece 100 to rotate about an axis perpendicular to the length of the body 102 from proximal end 105 to distal end 110.

In some embodiments, the proximal end 105 is configured with grooves, ridges, and/or other surface features to create a quick disconnect type fitting. The channel 104 provides an internal passage through the body 102 to allow a fluid to flow into the body 102 at or near the distal end 110, and exit the body 102 at the proximal end 105.

A tab 120 is connected to the body 102. The tab 120 protrudes angularly from the axis between the proximal end 105 and the distal end 110. The tab 120 enables a user to apply a force to the tab 120 which will cause the body 102 to rotate about the axis described above.

In some embodiments the body 102 is monolithically formed, such as by casting, molding, machining, or other mechanisms of formation. In some embodiments, the body 102 is made from one or more pieces joined together via mechanical connectors, ultrasonic welding, heat pressing, and the like.

In some embodiments the attachment feature 115 is made from one or more pieces joined together via mechanic connects, ultrasonic welding, heating pressing, and the like.

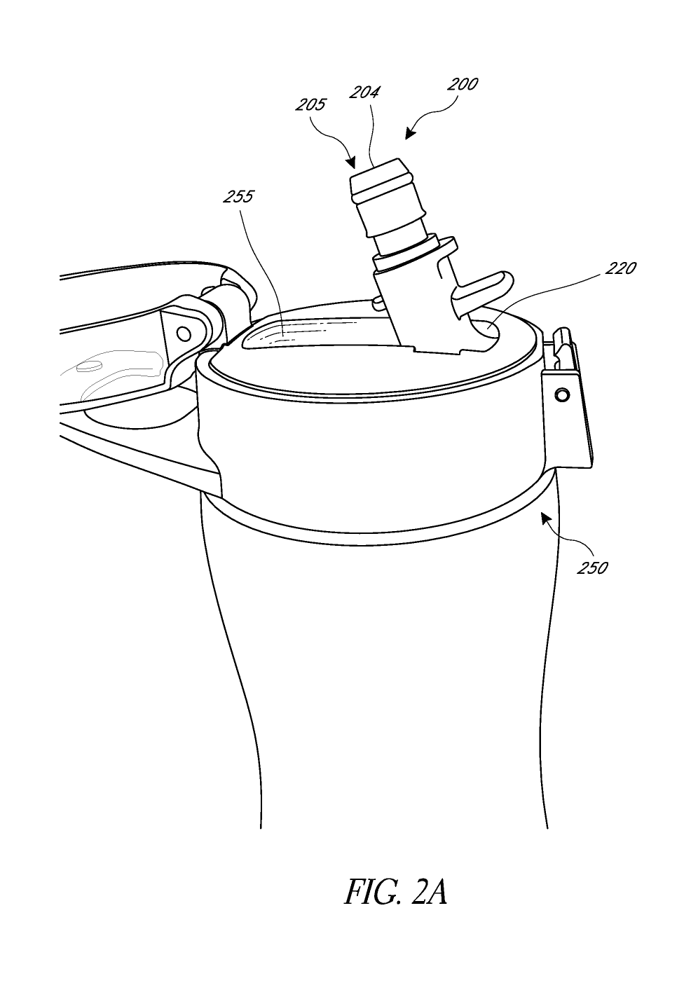

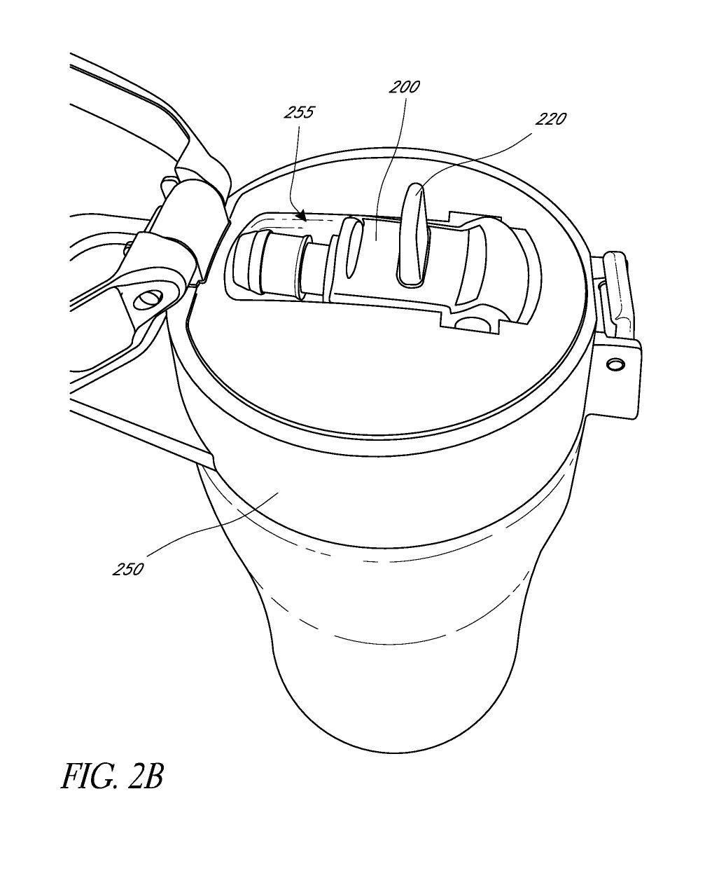

FIG. 2A depicts a mouthpiece 200 rotatably attached to a lid 250. The mouthpiece 200 may be similar to those described elsewhere herein. The lid 250 is sized, shaped, or configured to attach to a fluid reservoir 370, such as a water bottle. The lid 250 is formed with an indent 255 configured to receive the mouthpiece 200 as the mouthpiece 200 is rotated from a first position (as shown in FIG. 2A), where the channel 204 is exposed via the proximal end 205, to a second position (as shown in FIG. 2B) where the mouthpiece 200 fits within the indent 255.

FIG. 2B depicts the mouthpiece 200 in the second, or closed, position, with the mouthpiece 200 positioned within the indent 255. A tab 220 is disposed on the mouthpiece 200 to allow for a user to rotate the mouthpiece 200 from the first position to the second position, and vice versa.

In some embodiments, the mouthpiece 200 and lid 250 may be integrally formed. In some embodiments, the mouthpiece 200 may be configured to fit into existing lids upon removal of a mouthpiece which was sold or originally included with a lid. In some embodiments, the mouthpiece 200 and the lid 250 may be removably attached to each other such that the mouthpiece 200 can be removed from the lid 250 as desired by a user. The lid 250 includes a channel 204 formed therein (not shown) which allows a fluid to travel from the fluid reservoir, through the channel 204 in the lid 250, and into the channel 204 in the mouthpiece 200. When the mouthpiece 200 is in the first position, the channel 204 aligns with the channel in the lid 250. When the mouthpiece 200 is in the second position, the channel 204 does not align with the channel in the lid 250, and the flow of fluid through the lid 250 is blocked.

In some embodiments, the lid 250 need not include an indent 255, and the mouthpiece 200 need not be rotatably attached to the lid 250. In some embodiments, the mouthpiece 200 comprises a connection portion extending perpendicularly or at an angle from a top plane of the lid 250, and be attached to the lid 250 in a central portion of the lid 250. The mouthpiece 200 may not be rotatable, and can provide a quick disconnect-type connection.

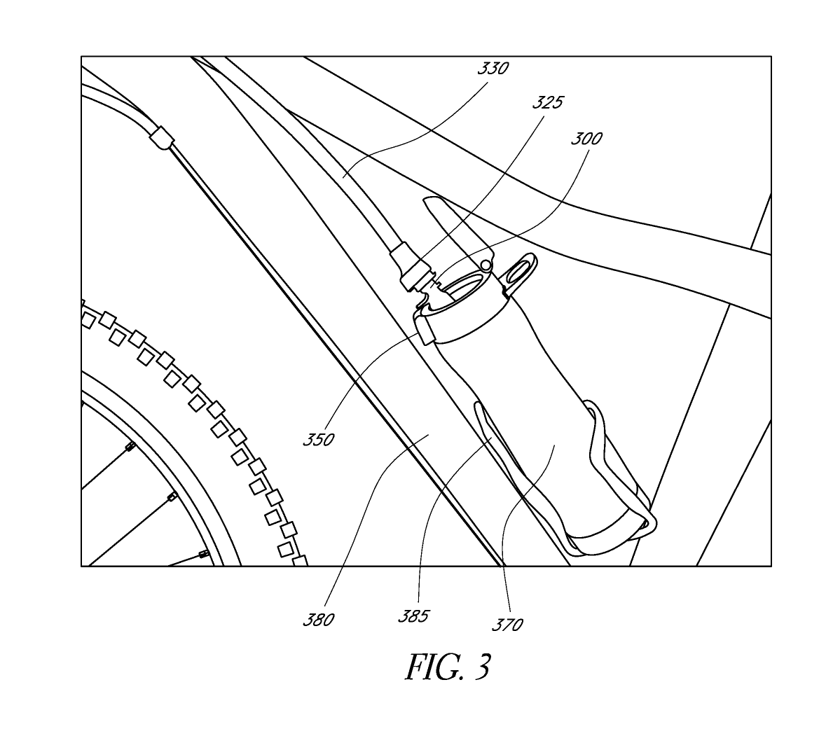

FIG. 3 depicts an embodiment of a fluid reservoir 370 attached to a frame 380 via a mount 385. A lid 350 is attached to the fluid reservoir 370, and a fitting 325 is connected to a mouthpiece 300. The fitting 325 is in fluid connection with tubing 330. The tubing 330 can be a flexible piece of tubing adapted to apply a motive force to a fluid contained within the fluid reservoir 370 sufficient to carry a fluid from the fluid reservoir 370, into the mouthpiece 300, through a channel in the mouthpiece 300, out the mouthpiece 300, and into the tubing 330. The motive force can be a vacuum pressure, such as when a user inserts a bite valve or straw (not shown), or other similar component into the user's mouth and inhales or sucks on the bite valve or the straw to draw a fluid out of the fluid reservoir 370. In some embodiments, the motive force can be pressurization of the fluid container through a pressurization port in the lid 350 similar to those described elsewhere herein.

The frame 380 shown is a portion of a bicycle, but a person of skill in the art would understand that the scope of the present disclosure is not limited thereto. Where the frame 380 is a bicycle, the tubing 330 is a flexible tubing that can be wrapped around or attached along one or more portions of the frame 380, and terminate in a bite valve (not shown) or other similar device, around the handle bars or in any other convenient location. As a rider rides the bicycle, the rider need not reach down and withdraw the fluid reservoir 370 from the mount 385, but can instead simply insert the bite valve (not shown) into his or her mouth and drink.

The fitting 325 attached to the tubing 330 can be a quick disconnect-type female fitting. The mouthpiece 300 can be the male counterpart to the fitting 325. A user can quickly and easily attach the fitting 325 to the mouthpiece 300 without the need for special equipment or tools. The fluid reservoir 370 can be of various shapes and sizes, and the lid 350 can be customized or manufactured to correspond to a particular fluid reservoir 370.

In some embodiments, the tubing 330, the fitting 325, and the mouthpiece 300 can be packaged together as a kit for use with an existing lid 350 and/or fluid reservoir 370. In some embodiments, the kit can also include the lid 350 and the fluid reservoir 370.

In some embodiments, the lid 350 may contain more than one outlet for more than one connection on the lid 350. In these embodiments, a lid 350 can attached to the fluid reservoir 370, and more than one fitting 325 can be connected to more than one outlet of the lid. The fittings 325 can be in fluid connection with more than one conduit or tubing 330. In some embodiments, as a rider rides the bicycle, the rider need not need to share the mouthpiece, but can provide another rider to drink from one of the other tubing 330 connected to another outlet on the lid 350. A user can quickly and easily attach at least one fitting 325 to each outlet on the mouthpiece 300 permitting each tubing to be accessible to different users. Outlets on the lid to which a fitting is not attached can be plugged, covered, or left open.

In some embodiments, the lid 350 can be formed with a vent hole therein to allow for the passage of a fluid, such as air. In the case where the fluid reservoir 370 is hard-sided or non-collapsible, the vent hole allows fluid to be withdrawn under a negative pressure via the mouthpiece 300 and the tubing 330.

In some embodiments, the tubing 330 can be made of silicon, rubber, plastic, metal or any non-toxic material suitable for fluids suitable for human consumption.

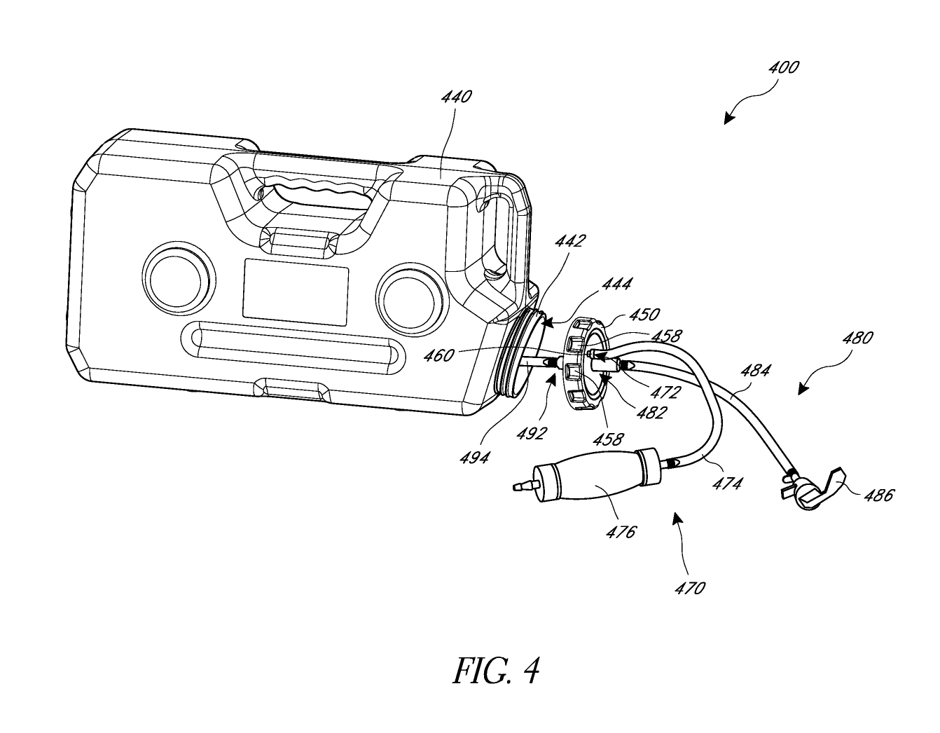

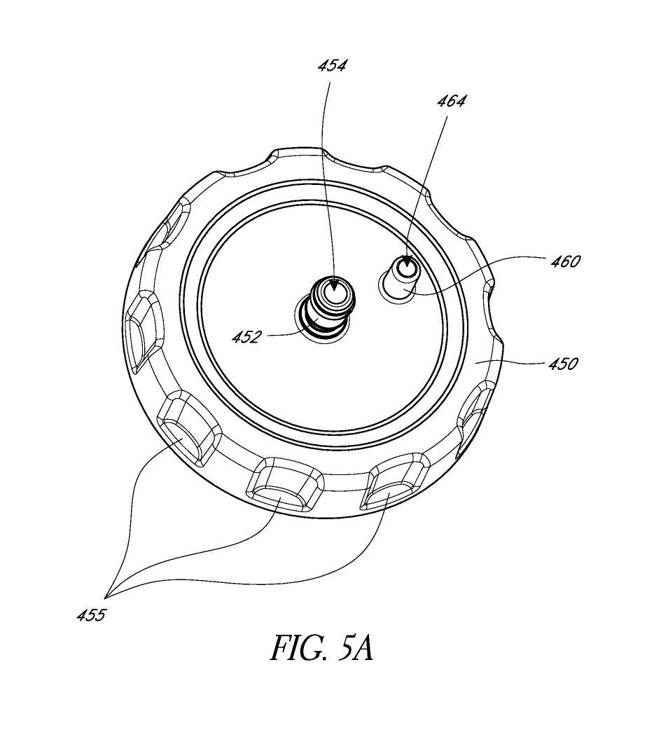

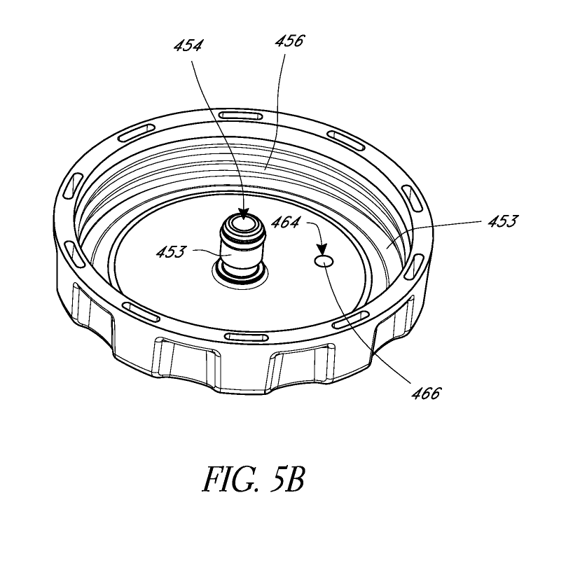

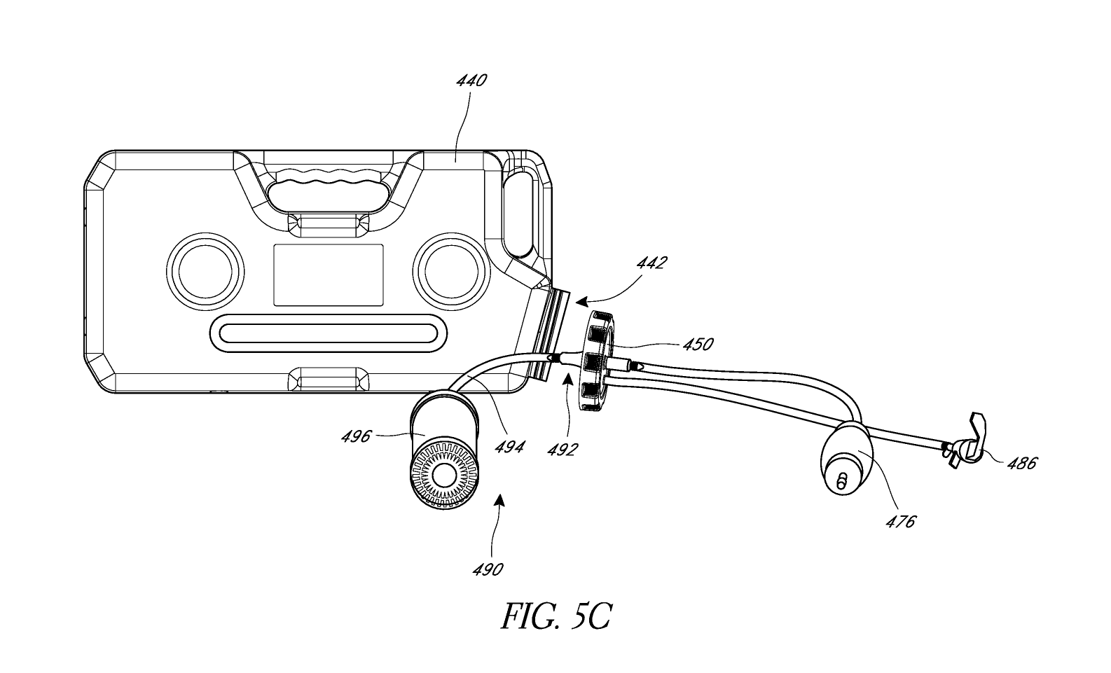

FIG. 4 depicts a fluid filter system for use on a fluid container. The filtering system 400 comprises a fluid container 440, a lid 450 having an outlet port (not shown) fixedly attached thereto, a pressurization port 460, a pressurization system 470, a discharge system 480, and a filter system 490 (FIG. 5C). The fluid container 440 includes an opening 444 which has threads 442 thereon. The opening 444 allows access to an internal volume of the fluid container.

The lid 450 comprises an external outlet port (452 on FIG. 5A), an internal outlet port (453 on FIG. 5B), a pressurization port 460, a threaded portion (456 on FIG. 5B) for attaching the lid 450 to threads 442 on the fluid container 440. The external outlet port 452 and the internal outlet port 453 are formed having an outlet channel 454 formed therein. The outlet channel 454 extends through the external and internal outlet ports 452 and 453 such that a fluid pathway is formed extending through the lid 450 allowing fluid communication between an internal volume of the fluid container 440 and an external environment of the fluid container.

The pressurization port 460 is formed having a pressurization channel 464 formed therein. The pressurization channel 464 extends through the lid 450 and provides a fluid communication path between an environment external to the fluid container 440 on which the lid 450 is located and the internal volume of the fluid container 440 on which the lid 450 is located. The pressurization port 460 can be configured to receive a portion of the pressurization system 470.

The pressurization system 470 includes a connection 472, a conduit 474 and a pressure source 476. The connection 472 is configured to mate with the pressurization port 460 and provide an air-tight or water-tight seal. To accomplish this seal, the connection 472 can utilize a hose clamp, a friction fit, a mechanical connector, a quick disconnect type fitting, an ultrasonic weld, and the like. In some embodiments, the connection 472 can be removably attached to the pressurization port 460, or can be integrally formed with the pressurization port 460. The connection 472 is in fluid communication with the conduit 474, which, in turn, is in fluid communication with the pressure source 480. The pressure conduit 460 can be a tube, pipe, or other means of transmitting a pressure or carrying a fluid, and can be made of plastic, polymeric, rubber, metal, or other desired material sufficient to contain a pressure generated by the pressure source 476.

The pressure source 476 provides a source of pressure to the pressurization port 460 via the pressure conduit 474 in order to pressurize the fluid container 440. The pressure source 476 can be a pump, an air tank, a high pressure reservoir, or other source of pressure. As depicted, the pressure source 476 is a hand pump which a user can squeeze using a hand to apply a pressure to the fluid container 440. Applying a pressure to the pressurization port 460 provides a motive force for moving fluid out of the fluid container via the external outlet port 452 and into the discharge system 480. In some embodiments, the pressure source 476 includes a check valve which prevents flow from the pressure conduit 474 back into the pressure source 476.

The discharge system 480 comprises a connection 482, discharge conduit 484, and a discharge valve 486. The connection 482 connects the discharge conduit 484 to the external outlet port 452. The connection 482 can be similar to the connection 472 described above with regard to the pressurization system. As depicted, the connection 472 comprises a female quick disconnect-type fitting adapted to connect to and mate with the external outlet port 452, which is shown as a male quick disconnect-type fitting. The discharge conduit 474 can be similar to conduit described elsewhere herein.

A discharge valve 486 is connected to the discharge conduit 484 by a connection similar to those described elsewhere herein. In some embodiments, the discharge valve 486 is fixedly attached to the discharge conduit 484 by a hose clamp, friction fit, or is integrally formed with the discharge conduit 484. The discharge valve 486 can be any kind of valve known in the art, and can be operated to inhibit or allow fluid to flow from the fluid container 440.

The filter system 490 comprises a connection 492, filter conduit 494, and a filter 496, as depicted in FIG. 5C. The connection 492 is adapted to connect the filter conduit 494 to the internal outlet port 453, as depicted in FIG. 5B, and can be similar to connections described elsewhere herein. As depicted in FIG. 5C, the connection 492 is a female quick disconnect-type fitting adapted to connect to and mate with the internal outlet port 453, which is depicted in FIG. 5B as a male quick disconnect-type fitting. The filter conduit 494 connects the connection 492 to the filter 496, and can be similar to conduit described elsewhere herein. The filter 496 is adapted to filter a fluid within the fluid container 440, for example, water, and filter particulate, microbial, and/or chemical species out of the fluid. The filter 496 can be constructed of one or more layers of filter media, such as a carbon layer, hollow fiber glass tubes, an activated charcoal, or other similar type of layer. The filter can also include filter media made of a thermally bonded blend of microglass fibers and cellulose infused with nanoalumina fibers to create an electropositively charged matrix of fibers, or any other desired filter material. A person of skill in the art would understand that the filter 496 may be of any desirable material or selected based on the fluid in the container to be filtered, or based the needs of the user, without departing from the scope of the present invention.

In some embodiments, the filter system 490 is comprised of a plurality of filters 496. In some embodiments, the plurality of filters can be configured in parallel with each other, such as with each filter having its own connection to the lid 450. In such embodiments, each filter of the plurality of filter can be rated to filter a specific volume of fluid per unit time, and the use of a plurality of filters can increase the amount of filtered fluid discharged from the container. In some embodiments, the plurality of filters can be configured in series, with the series of the plurality of filters having a single connection to the lid 450. In such embodiments, each of the plurality of filters can be configured to filter a different contaminant out of the water to provide high efficiency filtration of the fluid in the container.

In some embodiments, the lid 450 comprises a plurality of outlet ports 452 forming multiple fluid paths to a plurality of discharge systems 480. This can enable a user to discharge fluid from the fluid container 440 via multiple paths, such as into multiple containers, via a plurality of discharge valves 486. This can allow a user to use the filtered fluid drawn from the fluid container 440 for multiple uses without having to adjust or move the filter system 400 from one place to another.

In some embodiments, the filter system 400 may be capable of regulating the pressure of the fluid container 440. The lid 450 may have a valve capable of selectively allowing fluid to flow from the fluid container 440 to the outlet port 452 at or above a predetermined pressure in the fluid container 440 to regulate the pressure of the fluid container.

FIG. 5A depicts a top perspective view of the lid 450. As shown, the external outlet port 452 and the pressurization port 460 are integrally formed with the lid 450. In some embodiments, the external outlet port 452 and the pressurization port 460 can be removably attached or fixedly attached to the lid 450. Where the external outlet port 452 and the pressurization port 460 are removably attached to the lid 450, the lid 450 can comprise one or more one-way valves, or check valves, which are seated and closed when the external outlet port 452 and the pressurization port 460 are removed from the lid, so as to prevent fluid flow through the lid 450 and out of the fluid container 440.

The external outlet port 452 shown is a quick disconnect-type fitting, similar to the mouthpieces described elsewhere herein. In some embodiments, the external outlet port 452 can comprise a stub to which a friction fit or pressure fit connection fit, a hose clamp, or other types of fittings can be attached. The described fitting types are exemplary only, and the external outlet port 452 can be any desired type of fitting.

The lid 450 also includes gripping portions 455, which enable a user to grasp the lid 450 when attaching or removing the lid 450 to the fluid container 440. The gripping portions 455 provide surface area for a user's hand, to enable a user to hand tighten the lid 450 onto the container to provide a water or air-tight seal on the fluid container 440. The gripping portions 455 also provide adequate surface area for a user to remove such a hand-tightened lid 450.

FIG. 5B depicts a bottom perspective view of the lid 450. As noted above, the lid 450 comprises the internal outlet port 453 and a threaded portion 456. The lid 450 also comprises a pressurization port opening 466, disposed on the opposite as the pressurization port 460, and which corresponds with the pressurization channel 464 such that the pressurization port opening 466 comprises an outlet of the pressurization channel 464. The lid 450 also comprises a sealing surface 451 configured to contact a corresponding surface in the fluid container in order to provide a water-tight or air-tight seal. The sealing surface 451 can be an elastically deformable surface, a resilient surface, rubber, an O-ring, or other type of sealing surface sufficient to create a water or air-tight seal between the lid 450 and the fluid container 440.

FIG. 5C depicts the filter system 490 with the filter 496 not in the fluid container 440 and depicts the other components as described elsewhere herein.

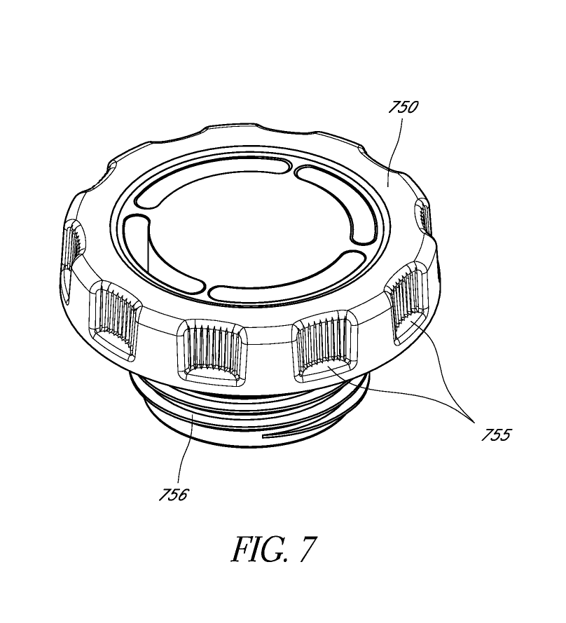

The operation of the filter system will be described with regard to FIGS. 4 and 5C. To use the filter system, the fluid container 440 can be oriented such that the opening in the filter container 440 is up, which will prevent spilling fluid when the fluid container 440 is opened. Initially, a cover which does not have penetrations and which seals the opening 444 in the fluid container 440, is removed from the fluid container. The cover can be similar to those described elsewhere herein, for example, with regard to FIG. 7. With the lid 450 in place, the fluid container 440 can be oriented in any desired orientation for use. After the filter system 400 is installed, the fluid container 440 can be oriented in various directions without causing the fluid to spill from the opening 444 in the fluid container 440.

The filter system 490, including the filter conduit and the filter 496, is attached to the internal outlet port 453 via the connection 492. The filter 496, attached to the filter conduit 494, is inserted into the opening 444 of the fluid container 440 and lowered into the internal volume of the fluid container 440. The filter 496 can advantageously rest on the bottom of the fluid container 440 in order to be surrounded by the fluid, such as being underwater, for the maximum time possible while removing fluid from the fluid container 440. If the filter is exposed to air or the void volume of the container, this may interrupt the flow of fluid from the fluid container 440 as pressure is applied.

The lid 450 is threaded onto or into, depending on whether the lid has male or female threaded portion 456. The pressurization system 470 is attached to the pressurization port 460 via the connection 472, as described elsewhere herein. The discharge system 480 is attached to the external outlet port 452 as described elsewhere herein. With the valve 486 closed, a pressure boundary is created between the fluid container 440, the sealing surface 451, the valve 486 and the pressurization source 476.

To operate the filter system, the pressurization source 476 is operated, for example, by squeezing the hand pump, pressure is generated in the fluid container 440 via the pressure conduit 474 and the pressurization port 460. The internal volume of the fluid container 440 is pressurized as desired. To initiate fluid flow, the valve 486 is opened, and the pressure in the fluid container 440 acts as a driving force to push fluid through the filter 496, into the filter conduit 494, through the lid 450 via the internal and external outlet ports 453, 452, into the discharge conduit 484, and out the valve 486. The fluid released through the valve 486 is a filtered fluid from the fluid container 440.

Although described with regard to the fluid container 440, a person of skill in the art would understand that similar processes and components can be used to filter a fluid from a container such as the fluid reservoir 370 (with a modification to lid 350 to allow for a pressurization port) or a 55-gallon barrel using a lid similar to the lid 650, or on any other desired container. A person of skill in the art would understand, guided by the current disclosure, how to provide a lid and filter system for various other types of containers in addition to those described explicitly herein.

The timing of attachment of the pressurization system 470, the discharge system 480, and the filter system 490 to the lid 450 described here are exemplary. For example, the pressurization system 470, the discharge system 480, and the filter system 490 could all be attached to the lid 450 before installing the lid 450 on the fluid container 440.

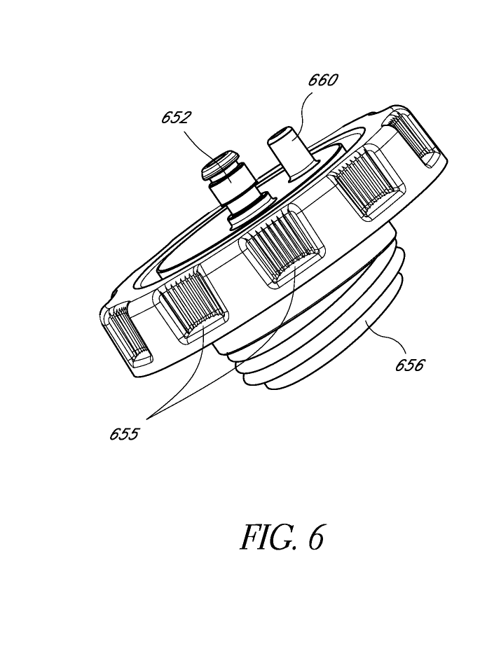

FIG. 6 depicts an embodiment of a lid having a male threaded portion and having a pressurization port. A lid 650 includes a male threaded portion 656. The male threaded portion 656 allows for attaching the lid 650 such as can be inserted into or installed on containers having a female threaded opening, such as a bung opening as can be found on a 55-gallon barrel or other similar container. The lid 650 can be used with a filter system 490, which includes a pressurization source 480, such as those described elsewhere herein, by attaching the filter system to an external outlet port 562, a pressurization port 660, and an internal outlet port (not shown). The lid 650 also comprises gripping portions 655. These gripping portions 655 enable a user to hand operate the lid 650 to attach the lid 650 to a container and remove the lid 650 from a container without the need for specialized tools. Existing 55-gallon barrels have lids without a portion that protrudes above the surface of the barrel, necessitating a specialized tool to remove the lid. This tool is often called a bung wrench, as it is used to remove a lid from the bung hole in a barrel. When the lid 650 is inserted into a standard 55-gallon barrel, the portion of the lid 650 having gripping portions 650 extends above the surface of the barrel so that a user can turn the lid 650 by hand.

In some embodiments, the lid 650 contains narrow threading while in some other embodiments the threading may be wide.

In some embodiments, the filtration system 400 can be adapted for use on a container having a bung lid by using the lid 650 depicted in FIG. 6. In some embodiments, the lid 650 is female threaded.

FIG. 7 depicts an embodiment of a lid having a male threaded portion which does not have a pressurization port. A lid 750 lacks an external outlet port and a pressurization port, but includes a male threaded portion 756 and gripping portions 755. The lid 750 can provide the advantages for installing and removing the lid 750 to a 55-gallon barrel as described with regard to FIG. 6. The lid 750 can be used as for sealing a fluid container, such as a 55-gallon barrel while the filter system is not in use. When a user desires to use the filter system described herein with a fluid container, such as a 55-gallon barrel, the user can easily remove the lid 750 from the barrel, and install lid 650, having the external outlet port 652 and pressurization port 660, install the filter system described herein, and withdraw water from the fluid container.

In some embodiments, the lid 750 contains fine threading while in some other embodiments the threading may be wide.

In some embodiments, the lid 750 threading is of a sufficient thickness which secures to a drum bung opening. In some embodiments, the lid 750 is female threaded.

In this section, certain specific details of the disclosed embodiments are set forth for purposes of explanation rather than limitation, so as to provide a clear and thorough understanding of the present invention. However, it should be understood readily by those skilled in this art, that the present invention may be practiced in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

The term “comprising” as used herein is synonymous with “including,” “containing,” or “characterized by,” and is inclusive or open-ended and does not exclude additional, unrecited elements or method steps.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this disclosure be limited to the specific embodiments disclosed herein, but that it cover all modifications and alternatives coming within the true scope and spirit of the disclosure as embodied in the attached claims.

What is claimed is:

1. A fluid filtration system comprising:
a lid configured to attach to a container, the lid comprising an outlet port and a pressurization port;
a filter in fluid communication with the outlet port;
a pressure source in fluid communication with the pressurization port;
an outlet valve in fluid communication with the outlet port; and
wherein the pressure source is configured to apply a pressure to the container to which the lid is attached sufficient to force a fluid in the container through the filter and out the outlet valve.

2. The fluid filtration system of claim 1, wherein the outlet port comprises an internal portion and an external portion, and wherein an outlet channel formed between the internal and external portions of the outlet port.

3. The fluid filtration system of claim 1, wherein the filter is directly connected to the outlet port.

4. The fluid filtration system of claim 1, further comprising a plurality of filters in fluid communication with the outlet port.

5. The fluid filtration system of claim 1, wherein the lid further comprises a plurality of outlet ports and a plurality of outlet valves in fluid communication with the plurality outlet ports.

6. The fluid filtration system of claim 1, wherein the pressurization port is formed having a pressurization channel formed therein, wherein the pressurization channel extends through the lid and provides a fluid communication path between an environment external to the fluid container on which the lid is located and the internal volume of the container on which the lid is located.

7. The fluid filtration system of claim 1, wherein the pressure source is a hand pump.

8. The fluid filtration system of claim 1, wherein the container comprises a bung orifice.

9. A method for fluid filtration from a container, comprising:
inserting a filter into a container holding a fluid;
attaching a lid to said container, the lid comprising an outlet port having an internal portion and an external portion, and a pressurization port;
attaching the filter to the internal portion of the outlet port on the lid;
attaching a pressure source to the pressurization port;
applying a pressure to the container from the pressure source sufficient to force a fluid in the container through the filter; and
attaching a discharge valve to the external portion of the outlet port; and
dispensing said fluid through the outlet port.

10. The method of claim 9 wherein the pressure source is a hand pump, and applying the pressure to the container comprises pumping the hand pump.

11. The method of claim 9, wherein the filter is attached to a first conduit, and wherein attaching the filter to the internal portion of the outlet port comprises attaching an end of the first conduit to the internal portion of the outlet port.

12. The method of claim 9, wherein attaching a discharge valve to the external portion of the outlet port comprises attaching a first end of a second conduit to the external portion of the outlet port and a second end of the second conduit to the discharge valve.

13. The method for fluid filtration of claim 11, wherein the lid comprises a plurality of outlet ports, and wherein inserting the filter into the container comprises inserting a plurality of filters into the container, and attaching a plurality of first conduits to a plurality of internal portions of the plurality of outlet ports.
